(19) United States
(12) Patent Application Publication
(10) Pub. No.: US 2008/0153379 A1
(43) Pub. Date: Jun. 26, 2008

(54) METHOD OF MANUFACTURING LIQUID CRYSTAL DISPLAY

(75) Inventors: Kazuya Kumazawa, Kanagawa (JP); Tsuyoshi Kamada, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 11/953,252

(22) Filed: Dec. 10, 2007

(30) Foreign Application Priority Data
Dec. 22, 2006 (JP) 2006-345897

(51) Int. Cl. H01J 9/26

(52) U.S. Cl. 445/25

(57) ABSTRACT

Provided is a method of manufacturing a liquid crystal display in which the aperture ratio of a panel is improved while maintaining good response characteristics against voltage, in a display mode using liquid crystal having negative dielectric constant anisotropy. The method of manufacturing a liquid crystal display comprising steps of: forming vertical alignment films on facing surfaces of a couple of substrates facing each other, respectively; subjecting the vertical alignment films to a rubbing process at least along one direction within planes of the substrates; sealing, between the couple of substrates with the vertical alignment films formed, a liquid crystal layer having a negative dielectric constant anisotropy and containing a curing material; and curing the curing material of the liquid crystal layer, under a voltage applied between the couple of substrates.

### CROSS REFERENCES TO RELATED APPLICATIONS

The present invention contains subject matter related to Japanese Patent Application JP 2006-345897 filed in the Japanese Patent Office on Dec. 22, 2006, the entire contents of which being incorporated herein by reference.

### BACKGROUND OF THE INVENTION

1. Field of the Invention

The present invention relates to a vertical alignment type liquid crystal display provided with a liquid crystal layer having a negative dielectric constant anisotropy.

2. Description of the Related Art

Recently, liquid crystal displays have been often used as display monitors of liquid crystal televisions, note book personal computers, car navigations and the like. The liquid crystal displays can be classified into different modes according to the molecular alignment between panel substrates of the liquid crystal displays. For example, a well known is TN (twisted nematic) mode configured by twisted alignment of liquid crystal molecules with no voltage applied thereto. In the TN mode, the liquid crystal molecules have a positive dielectric constant anisotropy, namely the property that the dielectric constant in the molecular long axis direction is larger than that in the molecular short axis direction. In the structure of the TN mode, the liquid crystal molecules are aligned in a direction vertical to the plane of the substrate, while rotating in sequence the alignment direction of liquid crystal molecules in a plane parallel to the substrate.

On the other hand, further attention is paid to VA (vertical alignment) mode where liquid crystal molecules with no voltage applied thereto are aligned vertically to the plane of the substrate. In the VA mode, the liquid crystal molecules have a negative dielectric constant anisotropy, namely the property that the dielectric constant in the molecular long axis direction is smaller than that in the molecular short axis direction. This realizes a wider viewing angle than the TN mode.

A liquid crystal display of the VA mode is configured to transmit light by the phenomenon that in response to the applied voltage, the liquid crystal molecules aligned vertically to the substrate will fall (rise) in a direction parallel to the substrate, due to the negative dielectric constant anisotropy. However, the liquid crystal molecules aligned vertically to the substrate will fall in arbitrary directions, so that the alignment direction of the liquid crystal molecules is uncertain. This contributes to deterioration of response characteristics against voltage.

In view of the foregoing, Japanese Unexamined Patent Application Publications No. 2002-357830 and No. 2002-23199 disclose methods of manufacturing a liquid crystal display in which monomers having photo-curing properties are used to stabilize the alignment direction of liquid crystal molecules. With these methods, the liquid crystal molecules can be held in their slightly tilted (pre-tilt) states by exposing a liquid crystal layer to cure the monomers in a state in which the liquid crystal molecules in the liquid crystal layer sealed between a pair of substrates are aligned in a certain direction. This improves response speed against voltage.

### SUMMARY OF THE INVENTION

However, in the abovementioned methods of the two publications, as alignment regulating means for aligning in a certain direction the liquid crystal molecules before curing the monomers, insulating projections or electrode slits (electrode-free portions) are formed within a pixel, at least on one of the facing surfaces of the substrates. With this configuration, for example, in normal black, the portions corresponding to the projections or the slits become dark visual fields when a voltage is applied. Due to this problem, the aperture ratio of a panel is lowered, causing a drop in luminance.

It is desirable to provide a method of manufacturing a liquid crystal display improving the aperture ratio of a panel while maintaining good response characteristics against voltage, in a display mode using liquid crystal having a negative dielectric constant anisotropy.

According to an embodiment of the present invention, there is provided a method of manufacturing a liquid crystal display including steps of: forming vertical alignment films on facing surfaces of a couple of substrates facing each other, respectively; subjecting the vertical alignment films to a rubbing process at least along one direction within planes of the substrates; sealing, between the couple of substrates with the vertical alignment films formed, a liquid crystal layer having a negative dielectric constant anisotropy and containing a curing material; and curing the curing material of the liquid crystal layer, under a voltage applied between the couple of substrates.

In the method of manufacturing a liquid crystal display according to an embodiment of the present invention, by sealing the liquid crystal layer between the pair of substrates with the vertical alignment films subjected to a rubbing process at least in one direction within the planes of the substrates, the liquid crystal molecules can be aligned in a slightly tilted position in the rubbing direction, in the vicinity of the interface with the vertical alignment films of the liquid crystal layer. Thereafter, by exposing the liquid crystal layer, with a voltage applied between the substrates, the liquid crystal molecules can be held in their pre-tilt states, based on the alignment characteristic regulated by the rubbing process.

The method of manufacturing a liquid crystal display includes steps of forming vertical alignment films on facing surfaces of a couple of substrates facing each other, respectively; subjecting the vertical alignment films to a rubbing process at least along one direction within planes of the substrates; sealing, between the couple of substrates with the vertical alignment films formed, a liquid crystal layer having a negative dielectric constant anisotropy and containing a curing material; and curing the curing material of the liquid crystal layer, under a voltage applied between the couple of substrates. Consequently, the liquid crystal molecules can be held in their pre-tilt states without forming any projections, slits etc in the substrates or the electrodes. This enables manufacture of the liquid crystal display improving the aperture ratio of the panel while maintaining good response characteristics against voltage.

Other and further objects, features and advantages of the invention will appear more fully from the following description.

### BRIEF DESCRIPTION OF THE DRAWINGS

FIG. 1 is a schematic cross-sectional view for explaining a method of manufacturing a liquid crystal panel according to a preferred embodiment of the present invention;

FIG. 2 is a schematic cross-sectional view for explaining the next succeeding step of FIG. 1;

FIG. 3 is a schematic cross-sectional view for explaining the next succeeding step of FIG. 2;

FIG. 4 is a schematic cross-sectional view of the liquid crystal panel manufactured through the steps in FIGS. 1 to 3;

FIG. 5 is a schematic cross-sectional view showing the alignment state of liquid crystal molecules when driving the liquid crystal panel of the preferred embodiment;

FIG. 6 is a schematic cross-sectional view for explaining a method of manufacturing a liquid crystal panel according to a modification of the present invention;

FIG. 7 is a schematic diagram for explaining a method of manufacturing a liquid crystal panel in related art;

FIG. 8 is a schematic cross-sectional view of a liquid crystal panel manufactured by the method shown in FIG. 7; and

FIG. 9 is a schematic cross-sectional view showing the alignment state of liquid crystal molecules when driving the liquid crystal panel of the related art.

### DESCRIPTION OF THE PREFERRED EMBODIMENTS

A preferred embodiment of the present invention will now be described in detail with reference to the accompanying drawings.

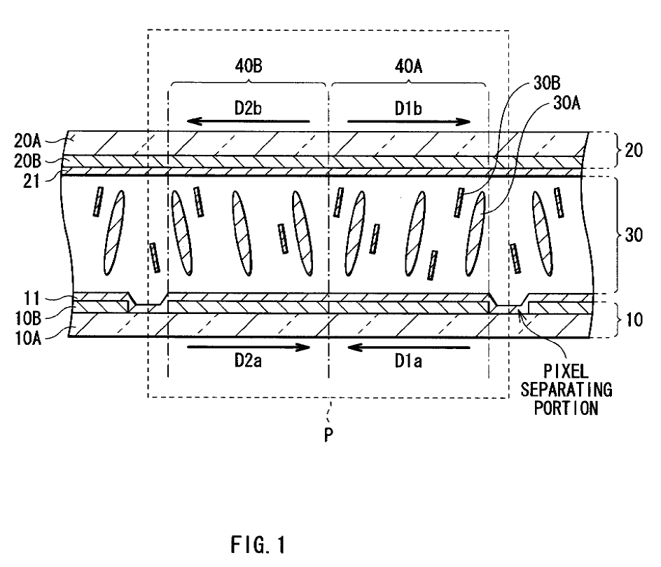

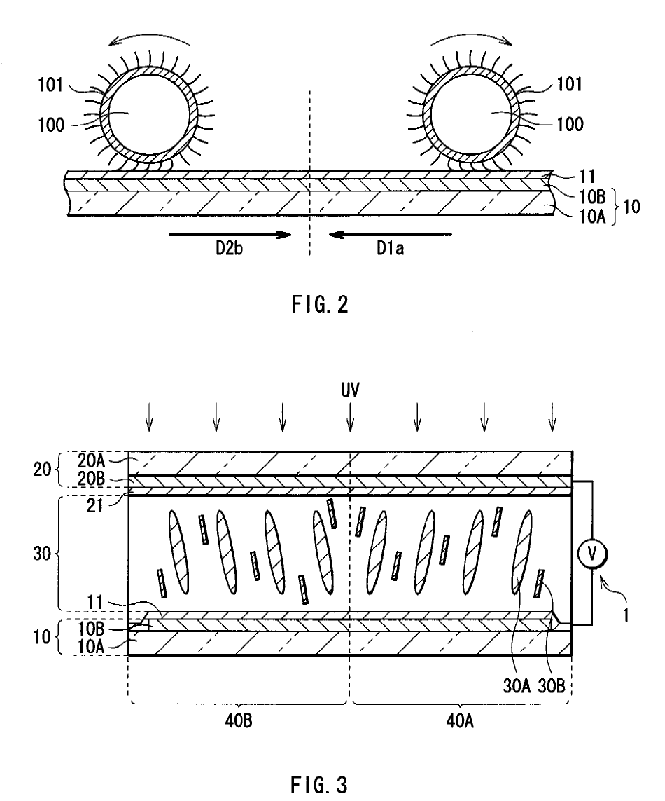

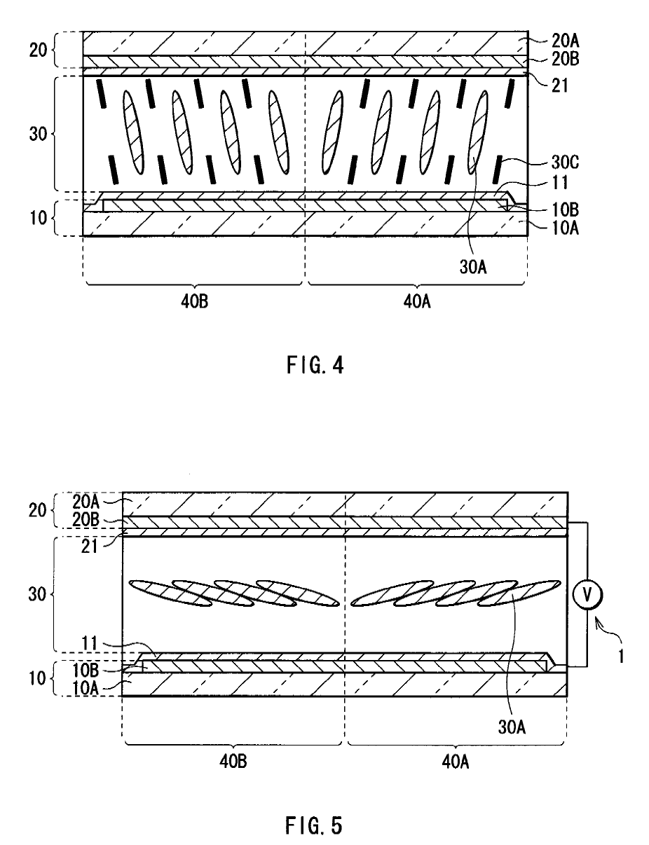

FIGS. 1 to 4 are cross-sectional views showing schematically the steps of a method of manufacturing a liquid crystal panel according to a preferred embodiment of the present invention. Specifically, this is a method of manufacturing a vertical alignment type liquid crystal display having a negative dielectric constant anisotropy, which includes the step of sealing a liquid crystal layer 30 between a TFT substrate 10 and a CF substrate 20, with vertical alignment films 11 and 21 in between; and the step of exposing the liquid crystal layer, with a voltage applied between the substrates 10 and 20. Particularly, the vertical alignment films 11 and 21 are subjected to a rubbing process at least in one direction within a pixel. This method is directed to a method of manufacturing a liquid crystal panel where a plurality of pixels are formed between the substrates 10 and 20. For sake of simplicity, FIGS. 3 and 4 show only a pixel P in FIG. 2. In FIGS. 1 to 4 and FIGS. 5 to 9, any specific configurations in the TFT substrate 10 and the CF substrate 20 are omitted.

Firstly, as shown in FIG. 1, the liquid crystal layer 30 is sealed between the TFT substrate 10 and the CF substrate 20, with vertical alignment films 11 and 21 subjected to a predetermined rubbing process in between.

The TFT substrate 10 is formed by arranging, on a surface of a glass substrate 10A, a plurality of pixel electrodes 10B, for example, in a matrix, a plurality of TFT switching elements each having a gate, a source and a drain for driving these pixel electrodes 10B, and a plurality of signal lines and scanning lines etc connected to these TFT switching elements, respectively. On the other hand, the CF substrate 20 is formed by disposing, on a glass substrate 20A, a color filter (not shown) where filters of, for example, red (R), green (G) and blue (B) are arranged in the shape of a stripe, and disposing opposed electrodes 20B over nearly the entire surface of an effective display region. The pixel electrodes 10B and the opposed electrodes 20B are made up of electrodes having transparency formed of ITO (indium tin oxide), or the like.

The vertical alignment films 11 and 21 are formed on the surfaces of the pixel electrodes 10B of the TFT substrate 10 and the opposed electrodes 20B of the CF substrate 20, respectively. The vertical alignment films 11 and 21, which are for vertically aligning liquid crystal molecules 30A described later with respect to the substrates, can be formed by applying a vertical alignment material, or alternatively by printing a vertical alignment layer on the substrates, followed by firing. Thereafter, the rubbing process is performed to the vertical alignment films 11 and 21 formed on the substrates 10 and 20, respectively. FIG. 2 shows schematically the rubbing process to the vertical alignment film 11 located on the TFT substrate 10.

As shown in FIG. 2, the rubbing process is performed, for example, by rotating in a predetermined direction rollers 100 with a fabric such as velvet 101 wound thereon, on the vertical alignment film 11 formed on the TFT substrate 10. Preferably, the directions of rotation (the rubbing directions) of the rollers 100 in a plane of the substrate differ from region to region within a pixel. For example, by rotating the rollers 100 in different directions for different regions as shown in FIG. 2, a first region having a rubbing direction D1 and a second region having a rubbing direction D2 may coexist.

When forming two or more regions having different rubbing directions, a mask (not shown) or the like is used to perform the rubbing process per region. For example, after the rubbing process is firstly performed in a direction on the vertical alignment film 11, a sensitive material such as photo resist is applied, and a selective region is exposed, thereby curing the resist material. The uncured portions of the resist material are then washed out with developer. Next, a rubbing process is performed in a different direction from the above rubbing direction. Similarly, photo resist is applied, and a selective region is exposed. These steps are repeated a plurality of times. Finally, the cured resist material is removed with remover, so that a plurality of regions having different rubbing directions can be formed with respect to the vertical alignment film 11 on the TFT substrate 10.

In the same manner as in the vertical alignment film 11 on the TFT substrate 10, a rubbing process is performed to the vertical alignment film 21 to be formed on the opposed electrodes 20B of the CF substrate 20. When the liquid crystal layer 30 described later is sealed between the substrates 10 and 20, the rubbing directions in the vertical alignment films 11 and 21 are required to be different from region to region in the liquid crystal layer 30. For example, for the vertical alignment type (VA) mode, rubbing directions (D1a, D2a) in the vertical alignment film 11 and rubbing directions (D1b, D2b) in the vertical alignment film 21 are opposite each other in a first region 40A and a second region 40B within a pixel, as shown in FIG. 1. However, according to the display mode of the liquid crystal panel, such as VA-TN mode, the rubbing directions between the upper and lower substrates are determined, which may be or may not be limited to the opposite directions between the substrates. Depending on the display mode, the upper and lower substrates may have the same rubbing direction.

For purposes of regulating the alignment direction of the liquid crystal molecules 30A described later, it is unnecessary to form any projected structures on the surface of the TFT substrate 10 and on the surface of the CF substrate 20, and it is also unnecessary to form any slits (electrode-free regions) in the pixel electrodes 10B and the common electrodes 20B.

The liquid crystal layer 30 is formed of liquid crystal molecules 30A having a negative dielectric constant anisotropy (negative type nematic liquid crystal molecules). The liquid crystal molecules 30A have the property that the dielectric constant in the molecular long axis direction is larger than that in the molecular short axis direction. Owing to this property, when a voltage is off, the long axes of the liquid crystal molecules 30A are aligned vertically to the substrates, and when the voltage is on, the long axes of the liquid crystal molecules 30A are aligned in a tilted position parallel to the substrates. The liquid crystal layer 30 is composed by adding monomers 30B having photo-curing properties. The photo-curing monomers 30B have the property that under irradiation of light such as ultraviolet light, they are polymerized to be polymer, thereby having curing properties. For example, the monomers 30B are composed of “NK ester A-BP-2E (product name),” manufactured by Shin-Nakamura Chemical Co., Ltd.

Next, spacers for ensuring a cell gap, such as plastic beads, are dispersed in either surface of the TFT substrate 10 or the CF substrate 20 thus formed, on which the vertical alignment film 11 or 21 is formed. Subsequently, a seal part is printed with epoxy adhesive etc by screen printing method etc. Thereafter, the TFT substrate 10 and the CF substrate 20 are stuck to each other, with the spacers and the seal part in between, so that the vertical alignment films 11 and 21 can be opposed to each other. It is followed by admission of the liquid crystal layer 30. The seal part is then cured by heating or the like so that the liquid crystal layer 30 is sealed between the substrates 10 and 20. Specifically, the liquid crystal layer 30 is sealed with the substrates 10 and 20 opposed to each other, so that the vertical alignment films 11 and 21 can have different rubbing directions for different regions (the first region 40A and the second region 40B).

Next, as shown in FIG. 3, the liquid crystal layer 30 is exposed with a voltage V applied between the substrates 10 and 20, sealing the liquid crystal layer 30 in between. The voltage V is 5 to 30V, for example, 10V. After retaining for a few minutes from the application of the voltage V, ultraviolet light UV is irradiated to the entire surface of the panel, so that the monomers 30A in the liquid crystal layer 30 can be cured (polymerized) to form polymer 30C.

After the foregoing steps, by irradiating again ultraviolet light UV to the entire surface of the panel with no voltage applied (not shown), the monomers 30B remaining in the liquid crystal layer 30 can be reduced to improve the reliability of the panel.

Thus, the liquid crystal panel as shown in FIG. 4 is completed through the foregoing steps. As shown in FIG. 4, in the liquid crystal layer 30 sealed between the TFT substrate 10 and the CF substrate 20, with the vertical alignment films 11 and 21 in between, the liquid crystal molecules 30A are aligned in their tilted positions in a certain direction (in their pre-tilt states) with respect to the line normal to the substrates, with no voltage applied. The pre-tilt states of the liquid crystal molecules 30A are held by the polymer 30C cured along the interface with the vertical alignment films 11 and 21 in the liquid crystal layer 30. Further, each pixel has the regions 40A and 40B having different alignment directions of the liquid crystal molecules 30A. Particularly, neither projections nor electrode slits for controlling these alignment directions are disposed on the liquid crystal panel, so that the TFT substrate 10, the CF substrate 20, the pixel electrodes 10 and the opposed electrodes 20B are continuous and flat with respect to the liquid crystal layer 30.

A description will next be made of the effect of the method of manufacturing the liquid crystal panel having the abovementioned configuration.

In the method of manufacturing a liquid crystal panel of the present embodiment, that is, the method of manufacturing the vertical alignment type liquid crystal panel having the negative dielectric constant anisotropy, the alignment characteristic of the liquid crystal molecules 30A can be regulated, namely the liquid crystal molecules 30A can be aligned in a slightly tilted position with respect to the line normal to the substrates, by performing the rubbing process in a predetermined direction to the vertical alignment films 11 and 21 formed on the TFT substrate 10 and the CF substrate 20, respectively, and then sealing the liquid crystal layer 30 between the vertical alignment films 11 and 21.

By applying a predetermined voltage V to between the substrates 10 and 20, sealing the liquid crystal layer in between, the liquid crystal molecules 30A can be tilted based on the alignment characteristic regulated by the rubbing process. By irradiating ultraviolet light UV to the entire surface of the panel in a state in which the liquid crystal molecules 30A are tilted under the voltage V, the monomers 30B can be cured to be the polymer 30C along the alignment direction of the tilted liquid crystal molecules 30A particularly in the vicinity of the interface with the vertical alignment films 11 and 21 in the liquid crystal layer 30. This enables the liquid crystal molecules 30A to be held in their pre-tilt states, without disposing any projections or slits on the substrates 10 and 20, and the electrodes 10B and 20B. The regions having different alignment directions (domain division of alignment) can be easily formed in the liquid crystal layer 30 by repeating the rubbing process a plurality of times in different directions from region to region in a pixel. This permits an improvement in the viewing angle characteristics of the panel.

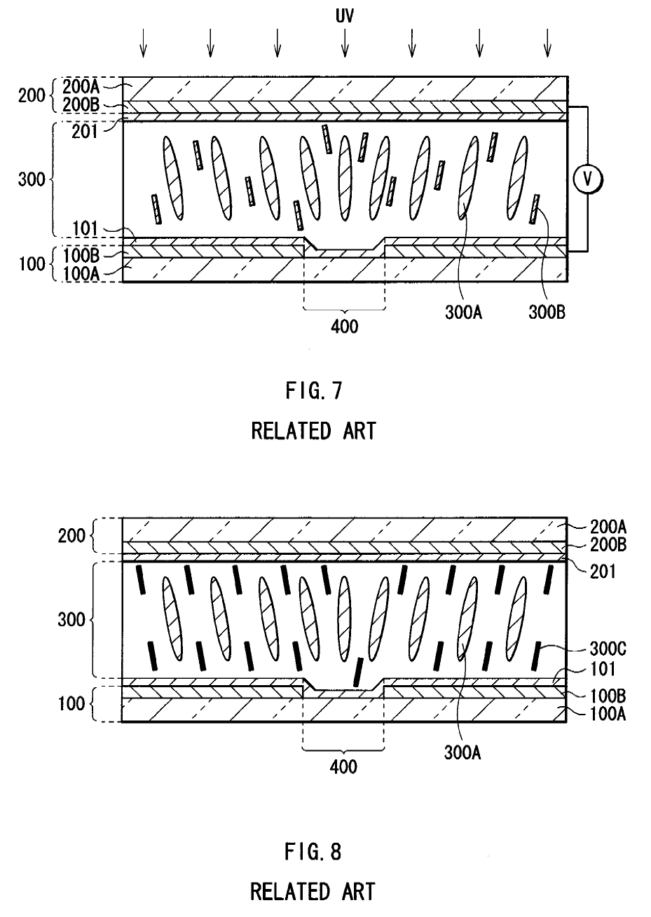

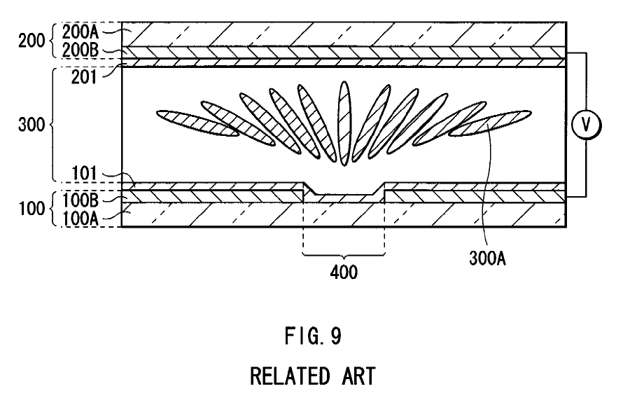

FIGS. 7 and 8 show schematically the alignment states of liquid crystal molecules 300A when the liquid crystal panel is manufactured by regulating the alignment characteristic of the liquid crystal molecules 300A by disposing slits 400 in part of pixel electrodes 100B, instead of the abovementioned rubbing process. Firstly, when a predetermined voltage is applied between substrates 100 and 200, sealing a liquid crystal layer 300 in between, an electric field is obliquely exerted on the long axes of the liquid crystal molecules 300A. As shown in FIG. 8, the liquid crystal molecules 300A, except for those immediately above the slits 400, their long axes are aligned in their tilted position in a certain direction. In this state, ultraviolet light UV is irradiated to the entire surface of the panel, so that the liquid crystal molecules 300A can be held in their pre-tilt states by polymer 300C, as shown in FIG. 9. When a driving voltage is applied to the liquid crystal panel thus manufactured, as shown in FIG. 10, the liquid crystal molecules 300A immediately above the slits 400 remain vertically aligned with respect to the substrates 100 and 200. Therefore, in the region in the vicinity of the slits 400, the liquid crystal molecules 300A are hardly tilted. For normal black, the regions corresponding to the slits 400 become dark viewing fields.

Whereas in the liquid crystal panel manufactured by the method of the present embodiment, in response to the applied driving voltage, the liquid crystal molecules 30A fall in a certain direction for each of the regions 40A and 40B. At this time, in the respective regions 40A and 40B in a pixel, the magnitude of the tilting angles of the liquid crystal molecules 30A are uniform, eliminating the possibility that the tilting angles of the liquid crystal molecules 30A vary depending on the region. Accordingly, the local dark viewing field due to the projections or electrode slits etc can be vanished while maintaining the good response characteristics against voltage. This enables manufacture of the liquid crystal panel with the improved aperture ratio of the panel.

### <Modification>

A modification of the method of manufacturing a liquid crystal panel according to the present embodiment will be described below.

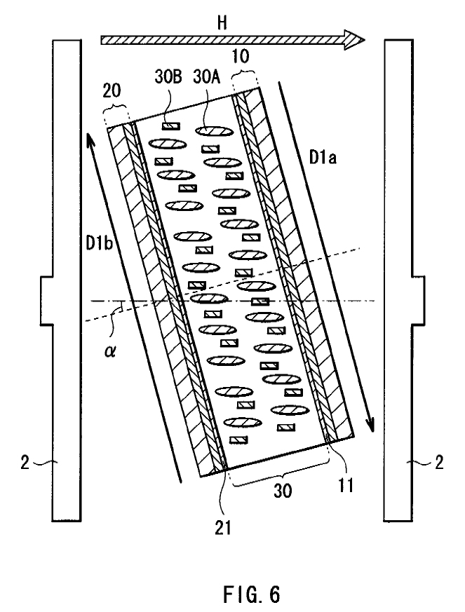

FIG. 6 is a cross-sectional view showing schematically a part of the steps in a method of manufacturing a liquid crystal panel according to the modification. This method is different from the method of the present embodiment in that the step of applying a magnetic field H in a predetermined direction with respect to the liquid crystal layer 30 is included after the step of sealing the liquid crystal layer 30 between the TFT substrate 10 and the CF substrate 20, with the vertical alignment films 11 and 21 subjected to a predetermined rubbing process in between, and before the step of exposing the liquid crystal layer 30 with a voltage V applied.

In the step of applying the magnetic field H, the magnetic field H is applied along the alignment direction of the liquid crystal molecules 30A regulated by the abovementioned rubbing process. For example, when the magnetic field H is applied to the liquid crystal layer 30 sealed between the substrates 10 and 20, interposing in between the vertical alignment films 11 and 21 subjected to rubbing processes in the opposite directions D1a and D1b, respectively, the panel is placed under the magnetic filed H so that the magnetic field H is applied in the long axis direction of the liquid crystal molecules 30A tilted with respect to the line normal to the substrates, as shown in FIG. 6. An angle α formed between the direction of application of the magnetic field H and the line normal to the substrates 10 and 20 is not required to be identical to the tilting angle of the liquid crystal molecules 30A regulated by the rubbing process, and it may be in the range of 0°<α<90°. The voltage V may be applied with the magnetic field H applied. Alternatively, after applying the magnetic field H, the voltage V may be applied by temporarily taking the panel out of the magnetic field H.

Thus, the magnetic field H is applied in the predetermined direction with respect to the liquid crystal layer 30 after sealing the liquid crystal layer 30 between the TFT substrate 10 and the CF substrate 20, interposing in between the vertical alignment films 11 and 21 subjected to a predetermined rubbing process, and before exposing the liquid crystal layer 30 with the voltage V applied. This enables correction of slight variations in the alignment characteristic to be generated locally, which cannot be completely regulated only by the rubbing process. It is therefore possible to impart more accurate alignment characteristic to the liquid crystal molecules 30A.

Examples of the present embodiment will be described below.

### EXAMPLES

As an example, the following liquid crystal panel was manufactured in the following manner. Firstly, a vertical alignment film was applied to a TFT substrate, an array substrate having gate lines having a width of 15 μm, data lines having a width of 12 μm, a storage capacitor having a width of 20 μm, and pixel electrodes, and to a color filter substrate having a color filter, common electrodes and 4 μm-spacer projections. Subsequently, a rubbing process was performed to the respective substrates by using rolls with velvet wound thereon. Then, a resist material (for example, “TFR-970 PM 9CP,” manufactured by TOKYO OHKA KOGYO CO., LTD.) was applied to the respective substrates subjected to the rubbing processes, and the solvent was removed by high-temperature treatment. The substrates were then exposed through a mask having a predetermined pattern, and the uncured portions on the substrates were washed out with developer (for example, “NMD-3,” manufactured by TOKYO OHKA KOGYO CO., LTD.). Next, with respect to the substrates having a predetermined resist material pattern, a rubbing process was performed in a different direction from the first rubbing process, and the cured resist material was removed with remover (for example, “Remover 106,” manufactured by TOKYO OHKA KOGYO CO., LTD.). The substrates were stuck to each other so that the vertical alignment films subjected to the rubbing processes are opposed to each other. After a liquid crystal composition containing photo-curing monomers was admitted in drops, seal was cured. The photo-curing monomers contained in the liquid crystal composition were polymerized by applying a voltage of 10V to the manufactured liquid crystal panel, followed by exposing the entire surface of the panel after retaining this for from a several seconds to a several minutes. Then, the remaining monomers were reduced by ultraviolet light irradiation to the entire surface of the panel, with no voltage applied.

As a comparative example of the liquid crystal panel of the above example, a liquid crystal panel was manufactured in the same manner as in the above example, except that pixel electrodes and opposed electrodes had slit portions each having a width of 10 μm and spacing of 50 μm. The liquid crystal panel of the example and the liquid crystal panel of the comparative example were compared in terms of aperture ratio. The result was that the liquid crystal panel of the example provided an improvement of approximately 22% in aperture ratio over the liquid crystal panel of the comparative example.

While the present invention has been described by the foregoing embodiment and examples, without limiting to these, many changes and modifications may be made. For example, though the foregoing embodiment and examples have described the case of forming two regions having different rubbing directions, the number of the regions having different rubbing directions may be three or more. Alternatively, the rubbing process may be performed only one direction within a pixel.

It should be understood by those skilled in the art that various modifications, combinations, sub-combinations and alterations may occur depending on design requirements and other factors insofar as they are within the scope of the appended claims or the equivalents thereof.

What is claimed is:

1. A method of manufacturing a liquid crystal display comprising steps of:
forming vertical alignment films on facing surfaces of a couple of substrates facing each other, respectively;
subjecting the vertical alignment films to a rubbing process at least along one direction within planes of the substrates;
sealing, between the couple of substrates with the vertical alignment films formed, a liquid crystal layer having a negative dielectric constant anisotropy and containing a curing material; and
curing the curing material of the liquid crystal layer, under a voltage applied between the couple of substrates.

2. The method of manufacturing a liquid crystal display according to claim 1, wherein each pixel is divided into a plurality of regions, and
the rubbing process is performed along mutually different directions between the regions.

3. The method of manufacturing a liquid crystal display according to claim 2, including steps of,
performing a rubbing process in a direction,
performing a rubbing process in another direction in a state in which at least a part of the regions in each pixel is covered with a mask, and then
removing the mask.

4. The method of manufacturing a liquid crystal display according to claim 1, further including, before applying a voltage between the couple of substrates, a step of applying a magnetic field to the liquid crystal layer sealed between the couple of substrates, in a direction to form a predetermined angle with respect to a line normal to the substrates.
